(19) United States
(12) Patent Application Publication
(10) Pub. No.: US 2010/0293165 A1
(43) Pub. Date: Nov. 18, 2010

(54) Subscriber Identification System

(75) Inventors: Charles Eldering, Doylestown, PA (US); M. Lamine Sylla, New Britain, PA (US)

Correspondence Address: Carlineo, Spicer & Kee, LLC, 2003 S. Easton Road, Suite 208, Doylestown, PA, 18901, US

(73) Assignee: Prime Research Alliance E., Inc.

(21) Appl. No.: 12/843,576

(22) Filed: Jul. 26, 2010

Related U.S. Application Data
(63) Continuation of application No. 09/857,160, filed on Jul. 1, 2001, now abandoned.

(51) Int. Cl. G06F 17/30

(52) U.S. Cl. 707/737; 707/758; 707/E17.089

(57) ABSTRACT

A subscriber identification system 100 is presented in which subscriber selection data 250 including channel changes 134, volume changes 132, and time-of-day viewing information is used to identify a subscriber (user) 130 from a group of subscribers. In one instance, the subscriber selection data 250 is recorded and a signal processing algorithm such as a Fourier transform is used to produce a processed version of the subscriber selection data. The processed version of the subscriber selection data can be correlated with stored common identifiers of subscriber profiles to determine which subscriber 130 from the group is presently viewing the programming. A neural network or fuzzy logic can be used as the mechanism for identifying the subscriber 130 from clusters of information which are associated with individual subscribers.

### CROSS REFERENCE TO RELATED APPLICATION

This application is a continuation of U.S. patent application Ser. No. 09/857,160, filed Jul. 1, 2001, entitled Subscriber Identification System, which is the National Stage Application of International Patent Application PCT/US99/28600, filed Dec. 2, 1999, entitled Subscriber Identification System, the entire disclosures of which are incorporated herein by reference.

### BACKGROUND OF THE INVENTION

The ability to direct specific advertisements to subscribers of entertainment programming and users of on-line services is dependent on identifying their product preferences and demographics. A number of techniques are being developed to identify subscriber characteristics and include data mining techniques and collaborative filtering.

Even when subscriber characterizations can be performed, it is often the case that the television/set-top or personal computer that is receiving the programming is used by several members of a household. Given that these members of the household can have very different demographic characteristics and product preferences, it is important to be able to identify which subscriber is utilizing the system. Additionally, it would be useful to be able to utilize previous characterizations of a subscriber, once that subscriber is identified from a group of users. Known prior art for identifying users is based on the use of browser cookies to identify a PC machine when accessing a Web server. Browser cookies are well used in today's Internet advertising technology as described in the following product literature.

The product literature from Aptex software Inc., “SelectCast for Ad Servers,” printed from the World Wide Web site http://www.aptex.com/products-selectcast-commerce.htm on Jun. 30, 1998 discloses the product SelectCast for Ad Servers. SelectCast for Ad Servers, mines the content of all users' actions and learns the detailed interests of all users to deliver a designated ad. SelectCast allows advertisers to target audiences based on lifestyle or demography. SelectCast uses browser cookies to identify individuals.

The product literature from Imgis Inc., “AdForce” printed from the World Wide Web site http://www.starpt.com/core/ad_Target.html on Jun. 30, 1998 discloses an ad targeting system. AdForce is a full service end to end Internet advertising management including campaign planning and scheduling, targeting, delivering and tracking results. AdForce uses techniques such as mapping and cookies to identify Web users.

For the foregoing reasons, there is a need for a subscriber identification system which can identify a subscriber in a household or business and retrieve previous characterizations.

### SUMMARY OF THE INVENTION

The present invention encompasses a system for identifying a particular subscriber from a household or business.

The present invention encompasses a method and apparatus for identifying a subscriber based on their particular viewing and program selection habits. As a subscriber enters channel change commands in a video or computer system, the sequence of commands entered and programs selected are recorded, along with additional information which can include the volume level at which a program is listened. In a preferred embodiment, this information is used to form a session data vector which can be used by a neural network to identify the subscriber based on recognition of that subscribers traits based on previous sessions.

In an alternate embodiment, the content that the subscriber is viewing, or text associated with the content, is mined to produce statistical information regarding the programming including the demographics of the target audience and the type of content being viewed. This program related information is also included in the session data vector and is used to identify the subscriber.

In one embodiment, subscriber selection data are processed using a Fourier transform to obtain a signature for each session profile wherein the session profile comprises a probabilistic determination of the subscriber demographic data and the program characteristics. In a preferred embodiment a classification system is used to cluster the session profiles wherein the classification system groups the session profiles having highly correlated signatures and wherein a group of session profiles is associated with a common identifier derived from the signatures.

In a preferred embodiment, the system identifies a subscriber by correlating a processed version of the subscriber selection data with the common identifiers of the subscriber profiles stored in the system.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a context diagram of the subscriber identification system;

FIG. 2 illustrates an entity-relationship for the generation of a session data vector;

FIG. 3 shows an example of a session data vector;

FIG. 4 shows, in entity relationship form, the learning process of the neural network;

FIG. 5 illustrates competitive learning;

FIGS. 6A-6G represent a session profile;

FIG. 7 represents an entity relationships for classifying the sessions profiles;

FIG. 8 shows examples of fuzzy logic rules;

FIG. 9 shows a flowchart for identifying a subscriber;

FIG. 10 shows a pseudo-code for implementing the identification process of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

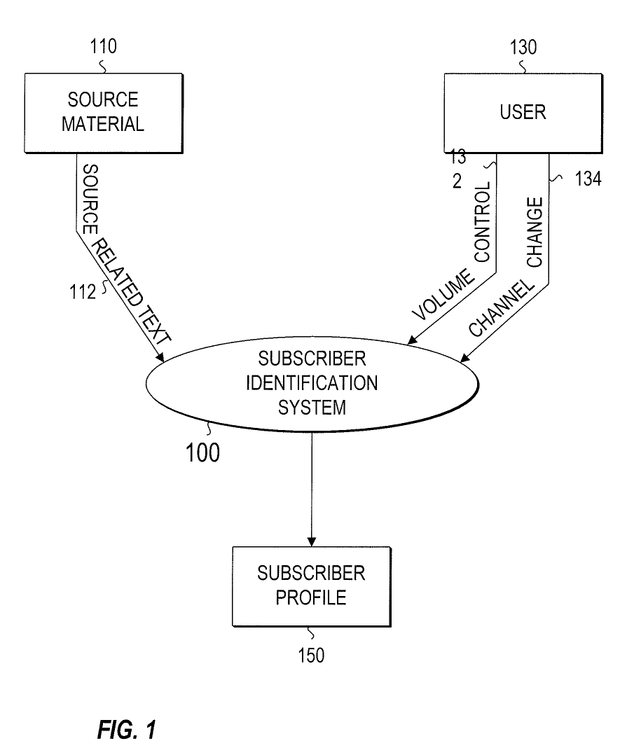

With reference to the drawings, in general, and FIGS. 1 through 10 in particular, the apparatus of the present invention is disclosed.

The present invention is directed at a method and apparatus for determining which subscriber in a household or business is receiving and selecting programming.

FIG. 1 shows a context diagram of a subscriber identification system 100. The subscriber identification system 100 monitors the activity of a user 130 with source material 110, and identifies the user 130 by selecting the appropriate subscriber profile from the set of subscriber profiles 150 stored in the system. The source material 110 is the content that a user 130 selects, or text associated with the source material. Source material 110 may be, but is not limited to, a source related text 112 embedded in video or other type of multimedia source material including MPEG source material or HTML files. Such text may derive from electronic program guide or closed captioning.

The activities of the user 130 include channel changes 134 and volume control signals 132. Subscriber identification system 100 monitors channel changes 134 as well as volume control signals activities, and generates session characteristics which describe the program watched during that session. The description of the program being watched during that session includes program characteristics such as program category, sub-category and a content description, as well as describing the target demographic group in terms of age, gender, income and other data.

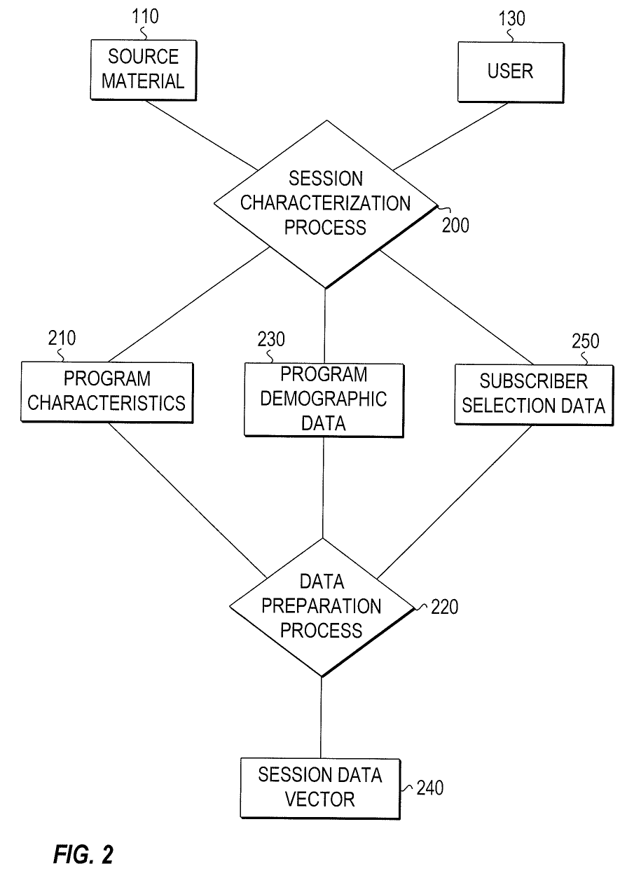

A session characterization process 200 is described in accordance with FIG. 2. A session data vector 240 which is derived in the session characterization process 200 is presented to a neural network 400, to identify the user 130. Identifying a user 130, in that instance, means determining the subscriber profile 150. The subscriber profile 150 contains probabilistic or deterministic measurements of an individual's characteristics including age, gender, and program and product preferences.

As illustrated in FIG. 2, a session data vector 240 is generated from the source material 110 and the activities of user 130. In a first step, the activities and the source material 110 are presented to the session characterization process 200. This process determines program characteristics 210, program demographic data 230 and subscriber selection data (SSD) 250.

The program characteristics 210 consist of the program category, subcategory and content description. These characteristics are obtained by applying known methods such as data mining techniques or subscriber characterization techniques based on program content.

The program demographic data 230 describes the demographics of the group at which the program is targeted. The demographic characteristics include age, gender and income but are not necessarily limited to.

The subscriber selection data 250 is obtained from the monitoring system and includes details of what the subscriber has selected including the volume level, the channel changes 134, the program title and the channel ID.

As illustrated in FIG. 2, the output of the session characterization process 200 is presented to a data preparation process 220. The data are processed by data preparation process 220 to generate a session data vector 240 with components representing the program characteristics 210, the program demographic data 230 and the subscriber selection data 250.

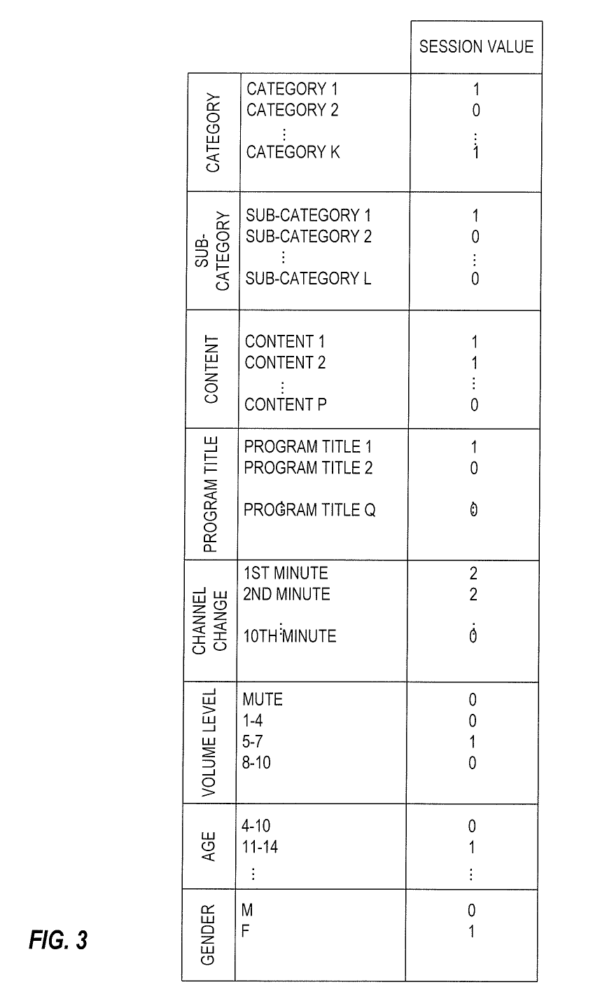

An example of session data vector is illustrated in FIG. 3. Session data vector 240 in FIG. 3 summarizes the viewing session of an exemplary subscriber. The components of the vector provide a temporal profile of the actions of that subscriber.

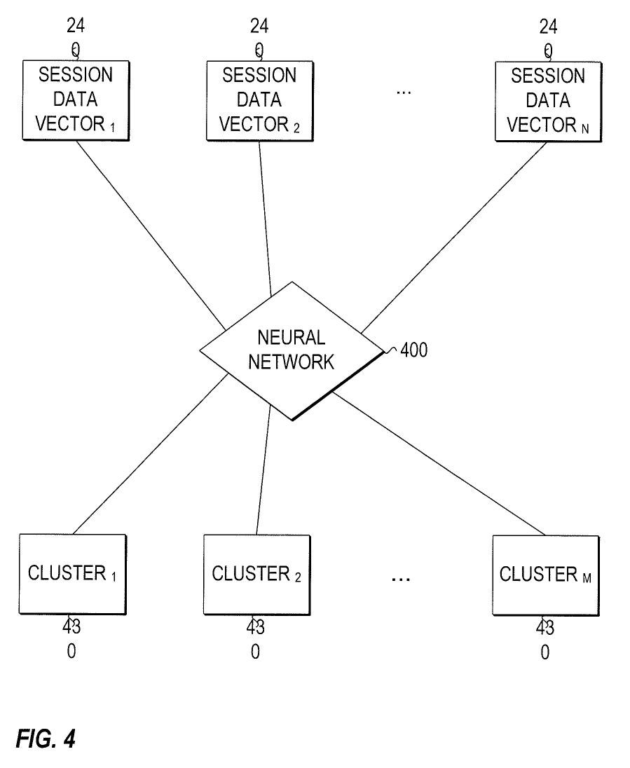

FIG. 4 illustrates the learning process of a neural network 400 which, in a preferred embodiment, can be used to process session data vectors 240 to identify a subscriber. As illustrated in FIG. 4, N session data vectors 240 are obtained from the data preparation process 220. Each session data vector 240 comprises characteristics specific to the viewer. These characteristics can be contained in any one of the vector components. As an example, a particular subscriber may frequently view a particular sit-com, reruns of a sit-com, or another sit-com with similar target demographics. Alternatively, a subscriber may always watch programming at a higher volume than the rest of the members of a household, thus permitting identification of that subscriber by that trait. The time at which a subscriber watches programming may also be similar, so it is possible to identify that subscriber by time-of-day characteristics.

By grouping the session data vectors 240 such that all session data vectors with similar characteristics are grouped together, it is possible to identify the household members. As illustrated in FIG. 4, a cluster 430 of session data vectors 240 is formed which represents a particular member of that household.

In a preferred embodiment, a neural network 400 is used to perform the clustering operation. Neural network 400 can be trained to perform the identification of a subscriber based on session data vector 240. In the training session N samples of session data vectors 240 are separately presented to the neural network 400. The neural network 400 recognizes the inputs that have the same features and regroup them in the same cluster 430. During this process, the synaptic weights of the links between nodes is adjusted until the network reaches its steady-state. The learning rule applied can be a competitive learning rule where each neuron represents a particular cluster 430, and is thus “fired” only if the input presents the features represented in that cluster 430. Other learning rules capable of classifying a set of inputs can also be utilized. At the end of this process, M clusters 430 are formed, each representing a subscriber.

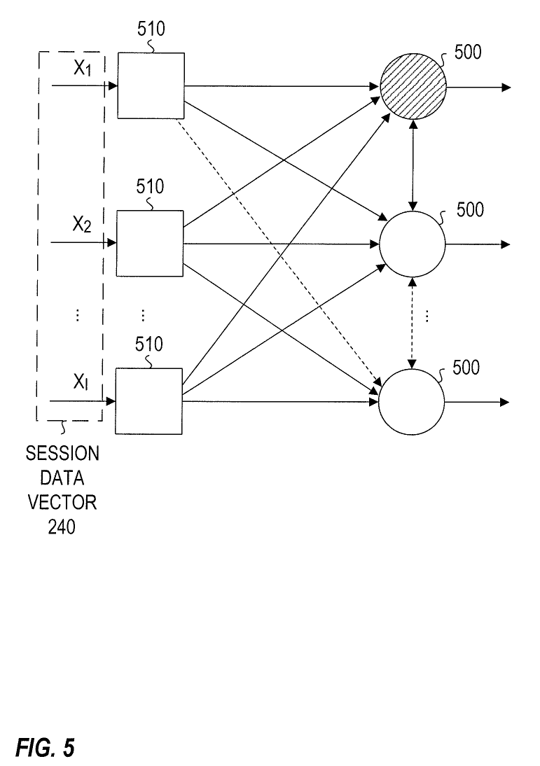

In FIG. 5 an example of competitive single-layer neural network is depicted. Such a neural network can be utilized to realize neural network 400. In a preferred embodiment a shaded neuron 500 is “fired” by a pattern. The input vector, in this instance a session data vector 240, is presented to input nodes 510. The input is then recognized as being a member of the cluster 430 associated with the shaded neuron 500.

In one embodiment, the subscriber selection data 250, which include the channel changes and volume control are further processed to obtain a signature. The signature is representative of the interaction between the subscriber and the source material 110. It is well known that subscribers have their own viewing habits which translates into a pattern of selection data specific to each subscriber. The so called “zapping syndrome” illustrates a particular pattern of selection data wherein the subscriber continuously changes channels every 1-2 minutes.

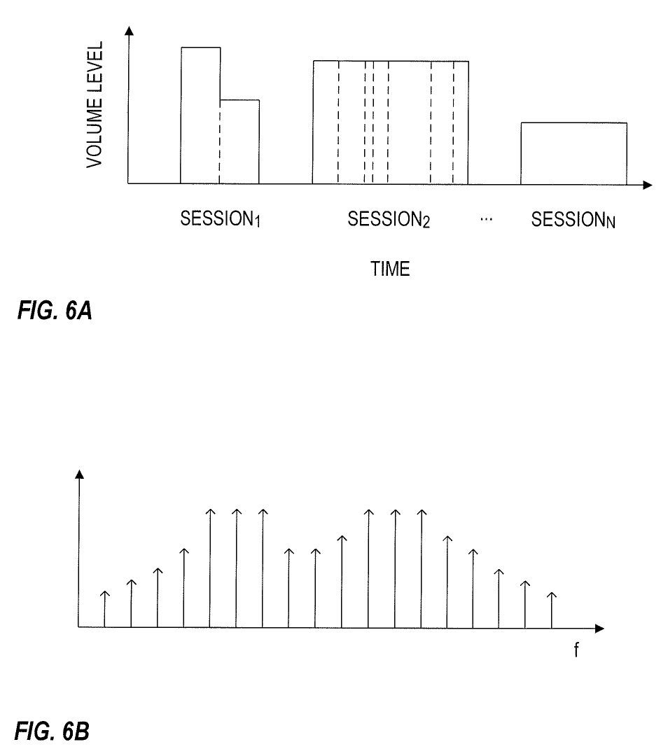

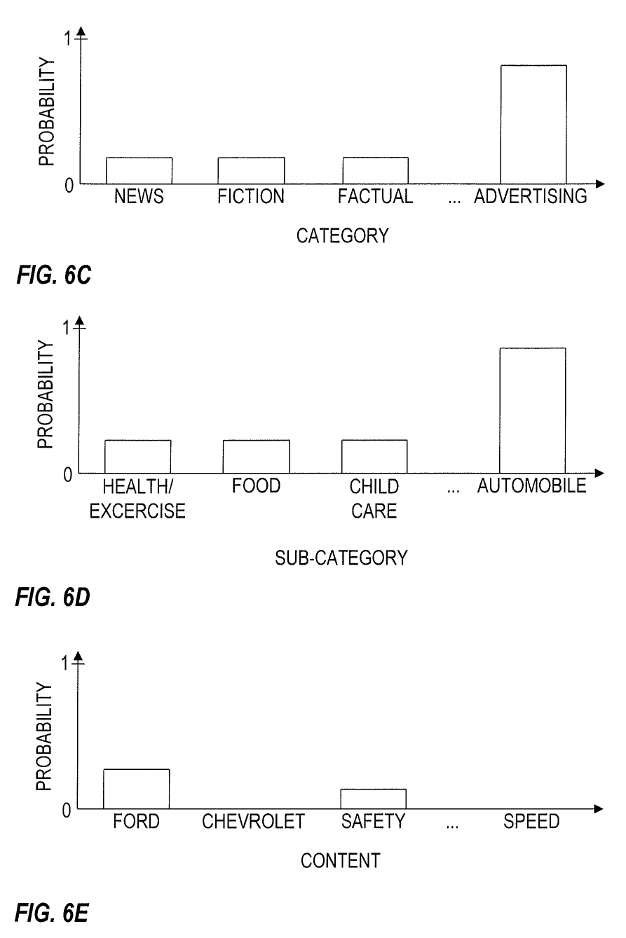

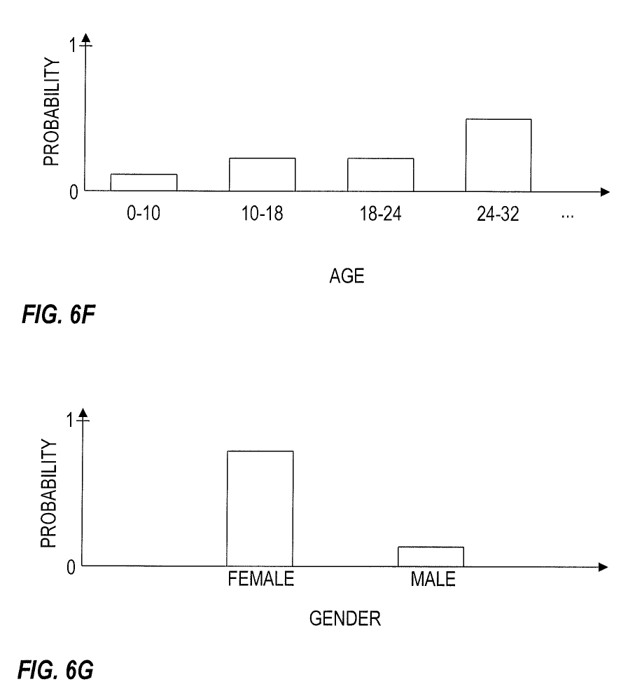

In a preferred embodiment, the signature is the Fourier transform of the signal representing the volume control and channel changes. The volume control and channel changes signal is shown in FIG. 6A, while the signature is illustrated in FIG. 6B. Those skilled in the art will recognize that the volume control and channel changes signal can be represented by a succession of window functions or rectangular pulses, thus by a mathematical expression. The channel changes are represented by a brief transition to the zero level, which is represented in FIG. 6A by the dotted lines.

The discrete spectrum shown in FIG. 6B can be obtained from the Digital Fourier Transform of the volume and channel changes signal. Other methods for obtaining a signature from a signal are well known to those skilled in the art and include wavelet transform.

In this embodiment of the present invention, the signature is combined with the program demographic data 230 and program characteristics 210 to form a session profile which is identified by the signature signal. The program demographic data 230 and program characteristics 210 are represented in FIGS. 6C through 6G. FIG. 6C represents the probabilistic values of the program category. FIGS. 6D and 6E represent the probabilistic values of the program sub-category and program content, respectively.

The program demographic data 230, which include the probabilistic values of the age and gender of the program recipients are illustrated in FIGS. 6F and 6G respectively.

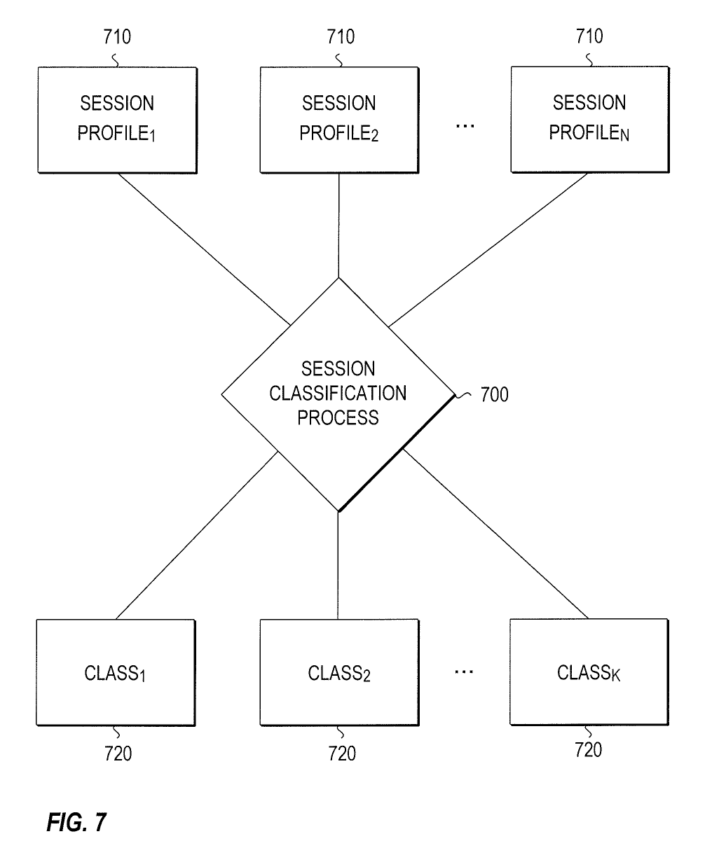

FIG. 7 illustrates the entity relationship for classifying the session based on the signature signal. In this embodiment, sessions having the same signature are grouped together. Session classification process 700 correlates the signature of different session profiles 710 and groups the sessions having highly correlated signatures into the same class 720. Other methods used in pattern classification can also be used to classify the session into classes. In this embodiment, each class 720 is composed by a set of session profiles with a common signature. The set of session profiles within a class can be converted into a subscriber profile by averaging the program characteristics 210 and the program demographic data 230 of the session profiles within the set. For example, the probabilistic values of the program category would be the average of all the probabilistic values of the program category within the set.

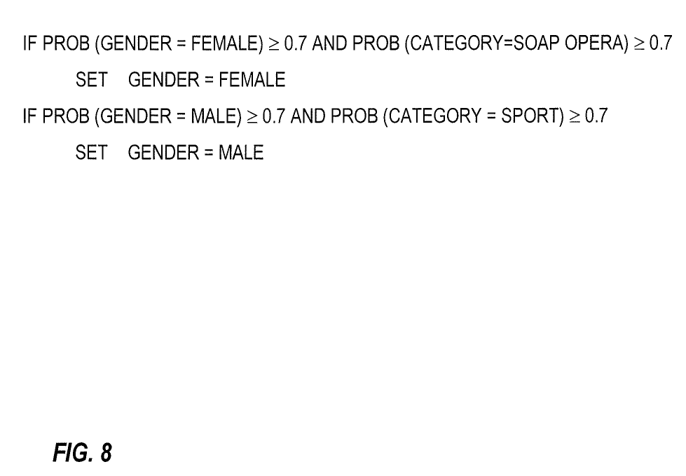

In one embodiment, a deterministic representation of the program demographic data 230 can be obtained by use of fuzzy logic rules inside the common profile. Examples of rules that can be applied to the common profile are presented in FIG. 8. In this embodiment, the program demographic data are probabilistic values, which describe the likelihood of a subscriber to be part of a demographic group. As an example, the demographic data can contain a probability of 0.5 of the subscriber being a female and 0.5 of being a male. By use of fuzzy logic rules such as those shown in FIG. 8, these probabilistic values can be combined with the probabilistic values related to program characteristics 210 to infer a crisp value of the gender. Fuzzy logic is generally used to infer a crisp outcome from fuzzy inputs wherein the inputs values can take any possible values within an interval [a,b].

The subscriber profile obtained from a set of session profiles within a class is associated with a common identifier which can be derived from the averaging of signatures associated with the session profiles within that class. Other methods for determining a common signature from a set of signatures can also be applied. In this instance, the common identifier is called the common signature.

In an alternate embodiment, the subscriber profile 150 is obtained through a user-system interaction, which can include a learning program, wherein the subscriber is presented a series of questions or a series of viewing segments, and the answers or responses to the viewing segments are recorded to create the subscriber profile 150.

In yet another embodiment, the subscriber profile 150 is obtained from a third source which may be a retailer or other data collector which is able to create a specific demographic profile for the subscriber.

In one embodiment, the subscriber profile 150 is associated with a Fourier transform representation of the predicted viewing habits of that subscriber which is created based on the demographic data and viewing habits associated with users having that demographic profile. As an example, the demonstrated correlation between income and channel change frequency permits the generation of a subscriber profile based on knowledge of a subscriber's income. Using this methodology it is possible to create expected viewing habits which form the basis for a common identifier for the subscriber profile 150.

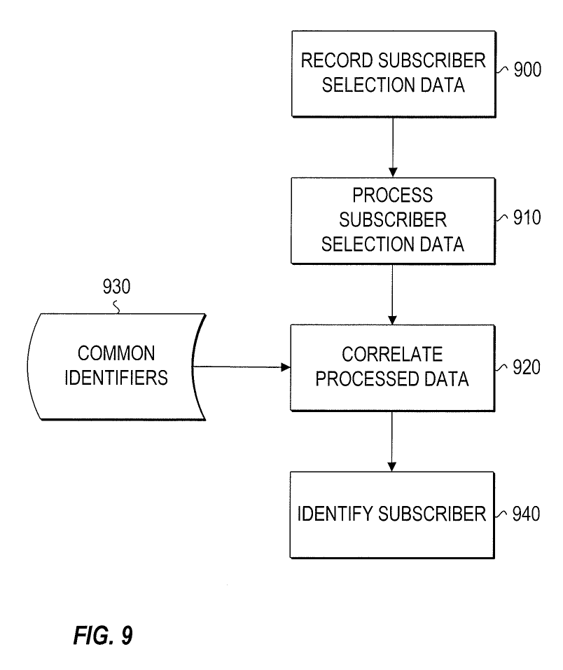

FIG. 9 illustrates a subscriber identification process wherein the subscriber selection data 250 are processed and correlated with stored common identifiers 930 to determine the subscriber most likely to be viewing the programming. As illustrated in FIG. 9, the subscriber selection data 250 are recorded at record SSD step 900. In a preferred embodiment, the subscriber selection data 250 are the combination of channel changes and volume controls. Alternatively, channel changes signal or volume control signal is used as SSD. At process SSD step 910, a signal processing algorithm can be used to process the SSD and obtain a processed version of the SSD. In one embodiment, the signal processing algorithm is based on the use of the Fourier transform. In this embodiment, the Fourier transform represents the frequency components of the SSD and can be used as a subscriber signature. At correlate processed SSD step 920 the processed SSD obtained at process SSD step 910 is correlated with stored common identifiers 930. Stored common identifiers 930 are obtained from the session classification process 700 described in accordance with FIG. 7. The peak correlation value allows determining which subscriber is most likely to be viewing the programming. At identify subscriber step 940, the subscriber producing the subscriber selection data 250 is then identified among a set of subscribers.

In one embodiment, the system can identify the subscriber after 10 minutes of program viewing. In this embodiment, a window function of length 10 minutes is first applied to subscriber selection data 250 prior to processing by the signal processing algorithm. Similarly, in this embodiment, the stored common identifiers 930 are obtained after applying a window function of the same length to the subscriber selection data 250. The window function can be a rectangular window, or any other window function that minimizes the distortion introduced by truncating the data. Those skilled in the art can readily identify an appropriate window function.

Alternatively, the identification can be performed after a pre-determined amount of time of viewing, in which case the length of the window function is set accordingly.

In the present invention, the learning process or the classification process can be reset to start a new learning or classification process. In one embodiment using Fourier transform and correlation to identify the subscriber, a reset function can be applied when the correlation measures between stored common identifiers 930 and new processed SSD become relatively close.

As previously discussed, identifying an individual subscriber among a set of subscribers can be thought as finding a subscriber profile 150 whose common identifier is highly correlated with the processed selection data of the actual viewing session.

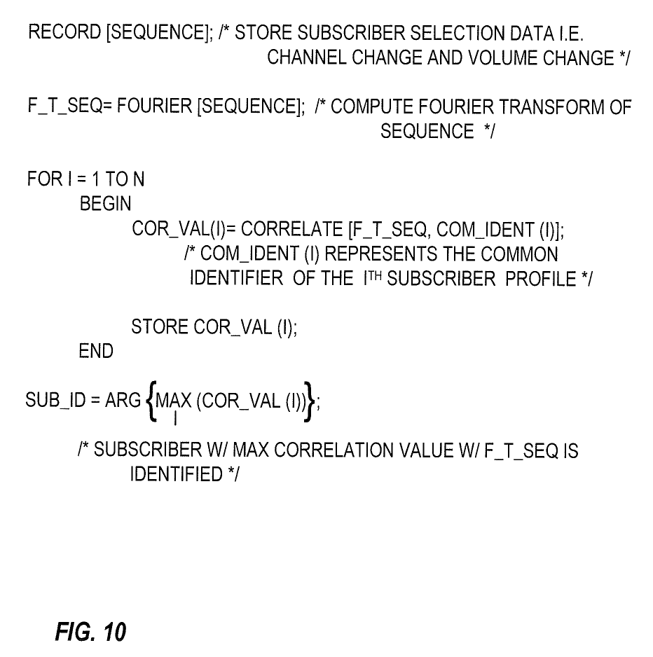

FIG. 10 illustrates a pseudo-code that can be used to implement the identification process of the present invention. As illustrated in FIG. 10, the subscriber selection data 250 of a viewing session are recorded. The subscriber selection can be a channel change sequence, a volume control sequence or a combination of both sequences. A Fourier transformation is applied to the sequence to obtain the frequency components of the sequence which is representative of the profile of the subscriber associated with the viewing session. In a preferred embodiment, the Fourier transform F_T_SEQ is correlated with each of the N common identifiers stored in the system. As illustrated in FIG. 10, the maximum correlation value is determined and its argument is representative of the identifier of the subscriber profile 150.

Although this invention has been illustrated by reference to specific embodiments, it will be apparent to those skilled in the art that various changes and modifications may be made which clearly fall within the scope of the invention. In particular, the examples of a neural network and Fourier transform are not intended as a limitation. Other well known methods can also be used to implement the present invention A number of neural network, fuzzy logic systems and other equivalent systems can be utilized and are well known to those skilled in the art. Additional examples of such alternate systems for realizing neural network 400 are described in the text entitled “Neural Networks, a Comprehensive Foundation,” by Simon Haykin, and in “Understanding Neural Networks and Fuzzy Logic,” by Stamatios V. Kartalopoulos, both of which are incorporated herein by reference.

The invention is intended to be protected broadly within the spirit and scope of the appended claims.

What is claimed is:

1) A method of identifying a first subscriber from a plurality of subscribers associated with subscriber equipment, the method comprising:
monitoring a plurality of first viewing sessions of the plurality of subscribers, each of the first viewing sessions comprising a plurality of first interactions with the subscriber equipment;
grouping the first viewing sessions into one or more subscriber profiles associated with one or more of the subscribers, wherein viewing sessions with common session characteristics are grouped together and wherein one of the subscriber profiles corresponds to the first subscriber;
monitoring a second viewing session, the second viewing session comprising a plurality of second interactions with the subscriber equipment; and
determining that the second viewing session matches the subscriber profile of the first subscriber based on a comparison between the plurality of second interactions and the common session characteristics of the subscriber profile of the first subscriber.

2) The method of claim 1, wherein the subscribers are not known to the subscriber equipment prior to the monitoring the first viewing sessions.

3) The method of claim 1, wherein the first and second interactions comprise channel change activities and volume control signal activities.

4) The method of claim 3, wherein the first interactions are processed to obtain a signature for each of the first and second subscriber profiles, each signature representative of the interaction between the subscriber and the subscriber equipment.

5) The method of claim 1, wherein the first and second subscriber profiles include probabilistic or deterministic measurements of the subscriber's characteristics.

6) The method of claim 1, wherein the monitoring the first viewing sessions further comprises generating a session data vector.

7) The method of claim 1, wherein the monitoring the first viewing sessions further comprises determining a time associated with each of the plurality of first viewing sessions.

8) A method of identifying a first subscriber from a plurality of subscribers associated with subscriber equipment, the method comprising:
monitoring a plurality of first viewing sessions of the plurality of subscribers, each of the first viewing sessions comprising a plurality of first interactions with the subscriber equipment;
processing the first interactions to obtain signatures for each of the first viewing sessions;
grouping the first viewing sessions having matching signatures, wherein each group of first viewing sessions corresponds to one of the subscribers;
monitoring a second viewing session, the second viewing session comprising a plurality of second interactions with the subscriber equipment; and
identifying the second viewing session as that of the first subscriber based on comparing the second interactions with the signatures.

9) The method of claim 8, wherein the signatures are based at least in part on information about channel changes and volume control signal activities.

10) The method of claim 8, wherein the grouping the first viewing sessions further comprises correlating the corresponding signatures.

11) The method of claim 8, wherein each of the first viewing sessions further comprises one or more probabilistic values representing program characteristics.

12) The method of claim 11, wherein subscriber profiles for the grouped first viewing sessions are generated based at least in part on the one or more probabilistic values representing program characteristics within the grouped first viewing sessions being averaged across the group.

13) The method of claim 11, wherein each of the first viewing sessions further comprises one or more probabilistic values representing program demographic data.

14) The method of claim 8, wherein the plurality of subscribers are not known to the subscriber equipment prior to the monitoring the plurality of first viewing sessions.

15) A system for identifying a first subscriber from a plurality of subscribers associated with subscriber equipment, the method comprising:
a monitoring module configured for:
monitoring a plurality of first viewing sessions of the plurality of subscribers, each of the first viewing sessions comprising a plurality of first interactions with the subscriber equipment; and
monitoring a second viewing session, the second viewing session comprising a plurality of second interactions with the subscriber equipment;
a processor configured for:
processing the first interactions to obtain signatures for each of the first viewing sessions;
grouping the first viewing sessions having matching signatures, wherein each group of first viewing sessions corresponds to one of the subscribers; and
identifying the second viewing session as that of the first subscriber based on comparing the second interactions with the signatures.

16) The system of claim 15, wherein the grouping the first viewing sessions further comprises correlating the corresponding signatures.

17) The system of claim 15, wherein each of the first viewing sessions further comprises one or more probabilistic values representing program characteristics.

18) The system of claim 17, wherein the processor is further configured for generating subscriber profiles for the grouped first viewing sessions based at least in part on averaging the one or more probabilistic values representing program characteristics within the grouped first viewing sessions.

19) The system of claim 17, wherein each of the first viewing sessions further comprises one or more probabilistic values representing program demographic data.

20) The system of claim 15, wherein the plurality of subscribers are not known to the system prior to the monitoring the plurality of first viewing sessions.
